(19) United States
(12) Patent Application Publication
(10) Pub. No.: US 2009/0009894 A1
(43) Pub. Date: Jan. 8, 2009

(54) COMBINED PRISMATIC CONDENSER BOARD

(76) Inventor: Chin-Lun Chuang, Chung Li City (TW)

Correspondence Address: LEONG C LEI, PMB # 1008, 1867 YGNACIO VALLEY ROAD, WALNUT CREEK, CA, 94598, US

(21) Appl. No.: 11/773,436

(22) Filed: Jul. 5, 2007

(51) Int. Cl. G02B 5/04

(52) U.S. Cl. 359/831; 359/431

(57) ABSTRACT

A combined prismatic condenser board includes a base having a surface on which a prismatic structure is formed. The prismatic structure includes a plurality of parallel rib-like prisms extending in a longitudinal direction and a plurality of parallel rib-like prisms extending in a lateral direction, which intersect each other. The rib-like prisms have a substantially triangular cross-sectional shape and have ridges that are selectively of different heights. With the rib-like prisms extending in different directions and having ridges of different heights, the combined prismatic condenser board realizes light condensation in the different directions and provides optimum view angles in the different directions.

### BACKGROUND OF THE INVENTION

(a) Technical Field of the Invention

The present invention relates to a prismatic condenser, and in particular to a prismatic condenser for a backlight module of a liquid crystal display, which effect light condensation in two perpendicular directions so as to ensure optimum view angle in both horizontal and vertical directions.

(b) Description of the Prior Art

A liquid crystal display includes one or two condenser boards arranged between a display panel and a light guide board so mat reflection or refraction of the light emitting from the light guide board can be effected by the condenser boards to properly focus onto the front panel of the display, resulting, in improved screen brightness.

FIG. 1 of the attached drawings illustrates a conventional condenser board, which comprises abase layer (1) on which a prismatic structure is formed. The prismatic structure comprises a plurality of parallel rib-like prisms (2). With such a structure, light emitting from a light guide board, once transmitting through the condenser; is subjected to reflection and/or retraction by the prismatic structure of the condenser to focus on a front panel of a display.

A practical application of the condenser is to simply enhance screen brightness of the display. However, condensation or focusing of the emitted light beam may result in reduction of view angle of the display screen and thus the conventional condenser board is subject to the undesired constraint imposed by the prismatic structure that the conventional condenser board only provides satisfactory performance in either the horizontal view angle or the vertical view angle, but not both.

As observed in FIG. 1, the prismatic structure of the conventional condenser includes only rib-like prisms (2) extending in the same, single direction. Thus, light condensation can only be effected in that single direction, so that the view angle in one direction is large, while that in another direction is comparatively small.

FIG. 2 illustrates another known condenser board, wherein a prismatic structure comprises a plurality of pyramids (3) closely distributed and arrayed on a base layer (4). The pyramids (3) that are closely arranged on the base layer (4) to form the prismatic structure are effective for light condensation in both horizontal and vertical directions, yet only can the same view angles be obtained for both the horizontal and vertical directions. Further, the pyramids (3) have sharp tips that are brittle and are subject to breaking in the manufacturing of the condenser and/or in the assembling of the backlight module, leading to poor passing rate of production.

U.S. patent application Ser. No. 11/129,477 filed by the present inventor also discloses a condenser board that effects light, condensation in both horizontal and vertical directions. In the prior patent application, a prismatic structure is composed of parallel rib-like prisms extending longitudinally and parallel rib-like prisms extending transversely that are both formed on a base layer to feature the condenser with light condensation in both the longitudinal direction and the transverse direction. Ridges of the rib-like prisms in both the longitudinal and transverse directions are of the same height so that the view angles in both directions are substantially identical.

The present invention is aimed to provide an improvement over the known prismatic structures of the conventional condensers to overcome the drawbacks of the known devices.

### SUMMARY OF THE INVENTION

The primary purpose of the present invention is to provide a combined prismatic condenser, which comprises a base layer on which a prismatic structure is formed. The prismatic structure is composed of a plurality of parallel rib-like prisms extending in a first, longitudinal direction and a plurality of parallel rib-like prisms extending in a second, lateral direction, wherein the longitudinally-extending prisms and the laterally-extending prisms are arranged to intersect each other. Both the longitudinally-extending prisms and the laterally-extending prisms have cross-sections that are of substantially triangular shapes, and have ridges that of different heights.

With the vertex angles of the ridges of both the longitudinally-extending rib-like prisms and the laterally-extending rib-like prisms set identical and fixed, when the heights of the ridges of the longitudinally-extending rib-like prisms and the laterally-extending rib-like prisms are different, the view angles in the horizontal and vertical directions are different from each other. The present invention uses parallel longitudinally-extending prisms and parallel laterally-extending prisms having different ridge heights formed on a base to both effect light condensation in both horizontal and vertical directions and provide different view angles in the horizontal and vertical directions, ensuring optimized view angles to satisfy requirements for view angle by different designs of liquid crystal displays.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional condenser board that has rib-like prisms extending in a single direction;

FIG. 2 is a perspective view of another conventional condenser board that comprises pyramids;

FIG. 3 is a perspective view of a combined prismatic condenser board constructed in accordance with the present invention;

FIG. 4 is an end view of a portion of the combined prismatic condenser board of the present invention;

FIG. 5 is an end view of a portion of a combined prismatic condenser board constructed in accordance with another embodiment of the present invention, wherein prisms in different directions have different ridge heights;

FIG. 6 is an end view of a portion of a combined prismatic condenser board constructed in accordance with a further embodiment of the present invention, wherein prisms extending in the same direction have different ridge heights; and

FIG. 7 is an end view of a portion of a combined prismatic condenser board constructed in accordance with yet a further embodiment of the present invention, wherein adjacent prisms extending in the same direction are spaced from each other.

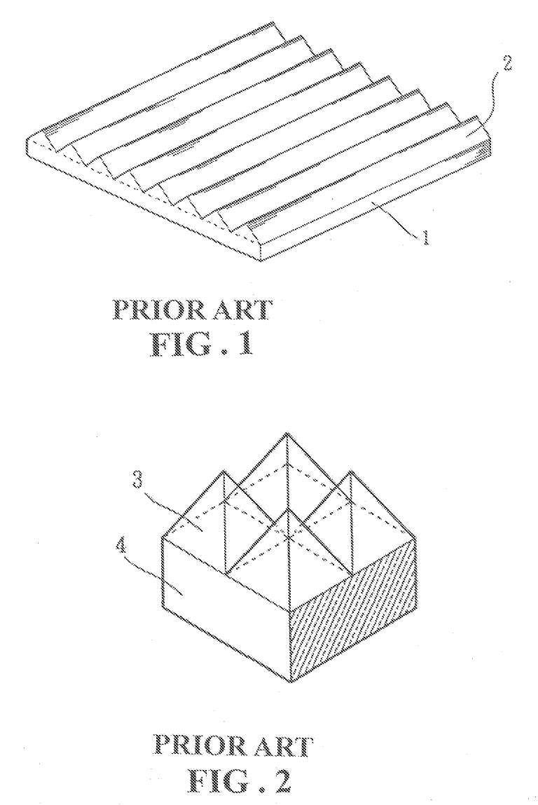

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

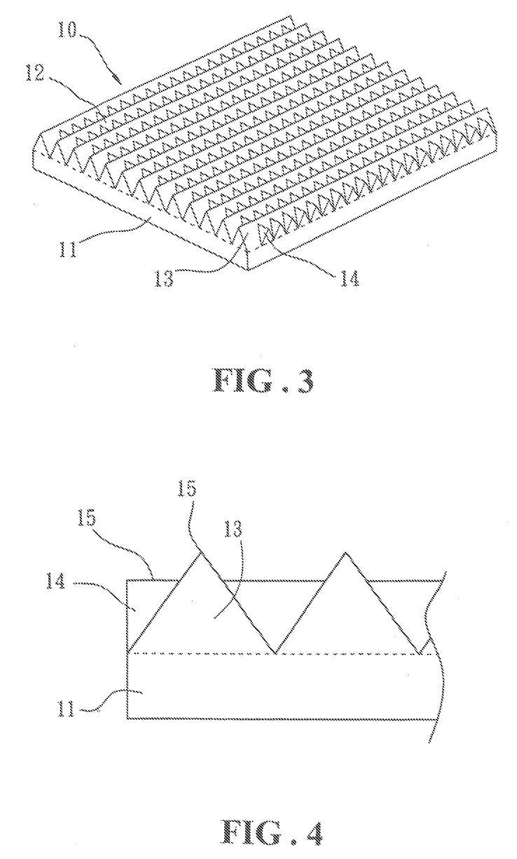

With reference to the drawings and in particular to FIG. 3, a combined prismatic condenser board constructed in accordance with the present invention, generally designated at (10), comprises a base (11) having a surface on which a prismatic structure (12) is formed. The prismatic structure (12) comprises a plurality of parallel rib-like prisms (13) extending in a first, longitudinal direction, and a plurality of parallel rib-like prisms (14) extending in a second, lateral direction, which are arranged to intersect each other. The first-direction prisms (13) and the second-direction prisms (14) are of triangular cross-sectional shapes each having a ridge (15) (see FIG. 4) having a height measured from the base (11) and forming an apex angle. The ridge heights of the first-direction prisms (13) and the second-direction prisms (14) are selectively different from each other.

As shown in FIG. 3, in accordance with the present invention, the parallel, first-direction rib-like prisms (13) and the parallel, second-direction rib-like prisms (14) that compose the prismatic structure (12) of the prismatic condenser (10) are preferably arranged to intersect each other at a right angle.

Referring to FIG. 4, another embodiment of the combined prismatic condenser board in accordance with the present invention is shown, wherein fee parallel, first-direction rib-like prisms (13) have a ridge (15) that has a height greater than a ridge (15) of the parallel, second-direction rib-like prisms (14).

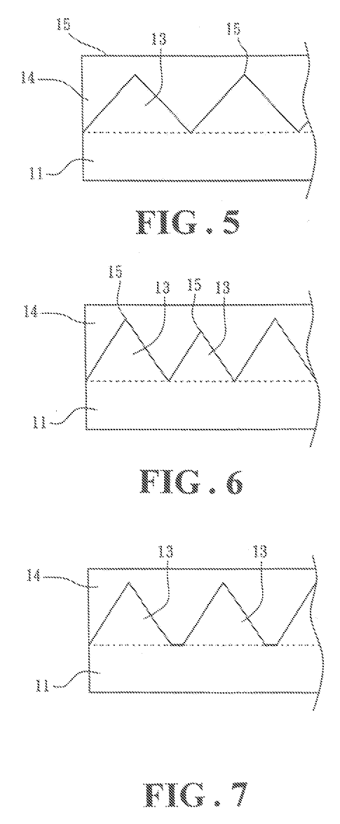

Referring to FIG. 5, a further embodiment of the combined prismatic condenser board in accordance with the present invention is shown, wherein the parallel, first-direction rib-like prisms (13) have a ridge (15) that has a height smaller than a ridge (15) of the parallel second-direction rib-like prisms (14).

Referring to FIG. 6, a further embodiment of the combined prismatic condenser board in accordance with the present invention is shown, wherein fee parallel rib-like prisms (13, 14) that extend in the same direction have ridges (15) that are selectively of identical and/or different heights.

Referring to FIGS. 3 and 7, in accordance with the present invention, the rib-like, triangular-cross-sectioned prisms (13, 14) may each have a ridge (15) defined by two opposite sides that are planar seduces or curved surfaces. In addition, each ridge (15) may have a sharp apex or a rounded apex. Further, adjacent prisms (13, 14) that extend in the same direction may be closely juxtaposing each other without a gap therebetween or they can be spaced from each other by a preset distance or gap as shown in FIG. 7. Further, if desired, a bottom of the base (11) that is opposite to the prismatic structure (12) can be provided with a light diffusion structure, which is made of a light diffusion material molded on or coated to the bottom of the base (11). If desired, a plurality of the prismatic condenser boards (10) of the present invention can be stacked and used together in a unitary form.

Although the present invention has been described with reference to the preferred embodiments thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A combined prismatic condenser board, comprising a base having a surface on which a prismatic structure is formed, the prismatic structure comprising a plurality of first rib-like prisms that are parallel and extend in a first direction and a plurality of second rib-like prisms that are parallel and extend in a second direction, the first and second directions intersecting each other, tire rib-like prisms having a substantially triangular cross-sectional shape, the rib-like prisms having ridges that are selectively of different heights.

2. The combined prismatic condenser board as claimed in claim 1, wherein the rib-like prisms that extend in the same direction have ridges that are selectively of different and/or same height.

3. The combined prismatic condenser board as claimed in claim 1, wherein the ridge of each rib-like prism is formed by two sides that are selectively of planar surfaces or curved surfaces.

4. The combined prismatic condenser board as claimed in claim 1, wherein the ridge of each rib-like prism forms an apex that is selectively sharp or rounded.

5. The combined prismatic condenser board as claimed in claim 1, wherein the rib-like prisms that extend in the same direction are arranged to be closely juxtaposing each other and/or spaced from each other by a preset distance.

6. The combined prismatic condenser board as claimed in claim 1, wherein the base has a bottom opposite to the prismatic structure, a light diffusion structure being provided on the bottom, the light diffusion structure being made of a diffusion material that is directly molded on the bottom or coated on the bottom.
